(19) United States
(12) Patent Application Publication
(10) Pub. No.: US 2006/0171181 A1
(43) Pub. Date: Aug. 3, 2006

(54) Sinewave inverter using hybrid regulator

(76) Inventor: Robert Clavel, St. Hurbert (CA)

Correspondence Address: GEORGE J. PRIMAK, 13480 HUNTINGTON, MONTREAL, QC, H8Z 1G2, CA

(21) Appl. No.: 10/549,007

(22) PCT Filed: Mar. 8, 2004
(86) PCT No.: PCT/CA04/00352

§ 371 Date: Sep. 14, 2005

(30) Foreign Application Priority Data
Mar. 17, 2003 (CA) 2,422,413

(51) Int. Cl. H02M 7/537

(52) U.S. Cl. 363/131

(57) ABSTRACT

A sinewave inverter for converting unstable DC voltage from a variable source such as batteries, fuel cells, wind mills and the like into a distortionless sinusoidal AC voltage of constant amplitude and constant frequency is provided. This pure sinewave inverter with line and load regulated voltage is obtained by using a combination of a hyperbolic frequency modulator with a sinusoidal pulsewidth modulator in the inverter circuit.

### FIELD OF THE INVENTION

The present invention relates to a sinewave inverter for converting DC to AC voltage, and more particularly to a kilowatts pure or distortionless sinewave inverter using a hybrid regulator comprising a hyperbolic frequency modulator combined with a sinusoidal pulsewidth modulator.

### BACKGROUND OF THE INVENTION

DC to AC inverters appeared about 60 years ago, mainly for aerospace applications. They used various voltage mode or current mode switching techniques, such as saturating magnetic core topologies or two current sources as disclosed, for instance, in U.S. Pat. No. 4,415,962.

Such inverters were simple in nature, but due to the non-linear phenomenon appearing in the magnetic core, they were difficult to regulate and predict. Filtering was not straightforward, because filters had to work with widely varying input and output impedances.

With the advent of microprocessors, sampling theories with custom made software algorithmns have been used to produce inverters with distortionless and regulated sinewaves. This approach works fairly well at low powers (below 300 watts), but becomes complicated and not too reliable at higher powers, because of the response of inductive power chokes and transformers to the sampling frequency, especially when loading is varying by large increments. The net result of this is high development, production and maintenance costs (around $1 to $2/watt) which amounts to $5000 to $10,000 for a 5 kw inverter. This is not commercially viable.

There is thus a need for a commercially viable pure sinewave inverter having essentially the following specifications:

1. Input unstable DC voltage (typically±50%) provided by batteries, fuel cells, wind mills, photovoltaic cells, solar cells, and the like;

2. Output: constant amplitude (typically 115 VAC±5%) and constant frequency (typically 60 hz+0.5 hz);

3. Pure sinewave: with typically less than 2% harmonic distortion;

4. Efficiency: at least 98%; and

5. Cost: low cost (typically in the range of $0.05/regulated watt).

At present, the above conditions cannot be achieved simultaneously, particularly in so far as the low cost is concerned for the high efficiency and other features set out above.

### SUMMARY OF THE INVENTION

According to the present invention, there is provided a sinewave inverter using a hybrid regulator for converting a direct current (DC) voltage to an alternating current (AC) voltage using a hyperbolic frequency modulation, i.e. a 1/x frequency modulation combined with a sinusoidal pulsewidth modulation to achieve the five inverter conditions mentioned above.

In U.S. Pat. No. 5,357,418 and the corresponding Canadian Patent No. 2,054,013 issued to the same inventor, which are incorporated herein by reference, it is already explained why, if a high frequency is made to vary inversely proportional (hyperbolic function) to the amplitude of a rectified and filtered AC and is subsequently used to switch the FETs of a push-pull device, the following desirable effects are produced:

after high speed rectification and filtering at the secondary of the transformer, a constant DC voltage is produced irrespective of the line voltage variations; and

the value of this DC voltage can be set merely by increasing or decreasing the pulsewidth from 0 to pwmax, with “pwmax” being the period of the variable frequency.

This is basically an open loop regulation scheme, the purpose of which is to obtain line regulation only.

After line regulation is obtained, a FET type linear regulation stage is added to take care of the load regulation. Due to the line-regulation, the drop across pass element is kept to a minimum and hence linear quality regulation is obtained for the fill load. At no load, the drop across the pass element increases, but current is negligible and losses in the pass element are also negligible.

Moreover, whatever the complexity of the load (inductive, capacitive, complex, abruptly varying, etc.), it does not interfere with the high frequency feedback loop or the complex impedances of the pre-regulator, avoiding a severe problem that usually exists with conventional switching regulators.

Thus, linear quality regulation (line and load) with high efficiency is made possible with this topology.

It has been surprisingly found that the converter topology described above, based on the use of 1/x or hyperbolic frequency modulation can also produce a sinewave inverter topology that essentially complies with the five above mentioned conditions, when it is combined with a sine pulsewidth modulation. In essence, the hybrid combination of hyperbolically modulated frequency combined with sinusoidally modulated pulsewidth produces a high efficiency linearly regulated AC supply from any type of DC input.

Thus, the present invention provides for a sinewave inverter characterized in that it comprises a combination of a hyperbolic frequency modulator with a sinusoidal pulsewidth modulator adapted to produce a line and load regulated distortionless sinusoidal voltage.

Preferably, the hyperbolic frequency modulator is adapted to produce high frequency which is exactly inversely proportional to a variable input DC voltage, and the pulsewidth modulator is adapted to produce a pulsewidth exactly proportional to the voltage of a sinusoidal distortionless reference voltage from a pure sinewave modulator. Moreover, the sinusoidal pulsewidth modulator may be adapted to produce a voltage which is exactly proportional to the voltage from a grid, thereby enabling the inverter to produce AC voltage which exactly mimics the grid voltage amplitude, frequency and waveshape and hence can deliver power to the grid.

Furthermore, the inverter of the present invention may comprise a precision full wave rectifier adapted to provide a reference signal from a master-slave arrangement suitable to deliver any desired power output.

In a preferred embodiment, the present invention provides a sinewave inverter using a hybrid regulator for converting DC input voltage from a variable DC source to pure sinewave line and load regulated AC voltage at the output, which comprises:

(a) a hyperbolic frequency modulator for producing high frequency which is exactly inversely proportional to the variable in put DC voltage;

(b) a voltage divider for feeding a faction of the input voltage to said hyperbolic frequency modulator;

(c) a sinusoidal pulsewidth modulator producing a pulse triggered by the modulated frequency from the hyperbolic frequency modulator and whose width is exactly proportional to the reference half sinewave amplitude from an internal or external sine reference source and a precision full wave rectifier;

(d) a pair of push-pull switching FETs connected to a bi-phase toggle which is triggered by the sinusoidal pulsewidth modulator and the hyperbolic frequency modulator and providing a flip-flop for the two phases of FET drives of the push-pull stage;

(e) a high frequency transformer following the push-pull stage connected to an integrating choke which itself is connected to a FET pass element used to produce a low drop linear regulator which is provided with an amplifier whose reference input receives half-sine waves from the linear regulator; and

(f) a FET synchronous bridge for converting the amplified half sine waves obtained from the linear regulator into full sinewaves of AC voltage at the output of the inverter.

### BRIEF DESCRIPTION OF THE DRAWINGS

The invention will now be described with reference to the appended drawings, in which:

FIG. 1 is a block diagram representing a preferred embodiment of the invention;

FIG. 2 is a graph showing main waveforms when the primary DC source delivers its minimum DC voltage; and

FIG. 3 is a graph showing main waveforms when primary DC source delivers its maximum DC voltage.

### DETAILED DESCRIPTION OF THE INVENTION

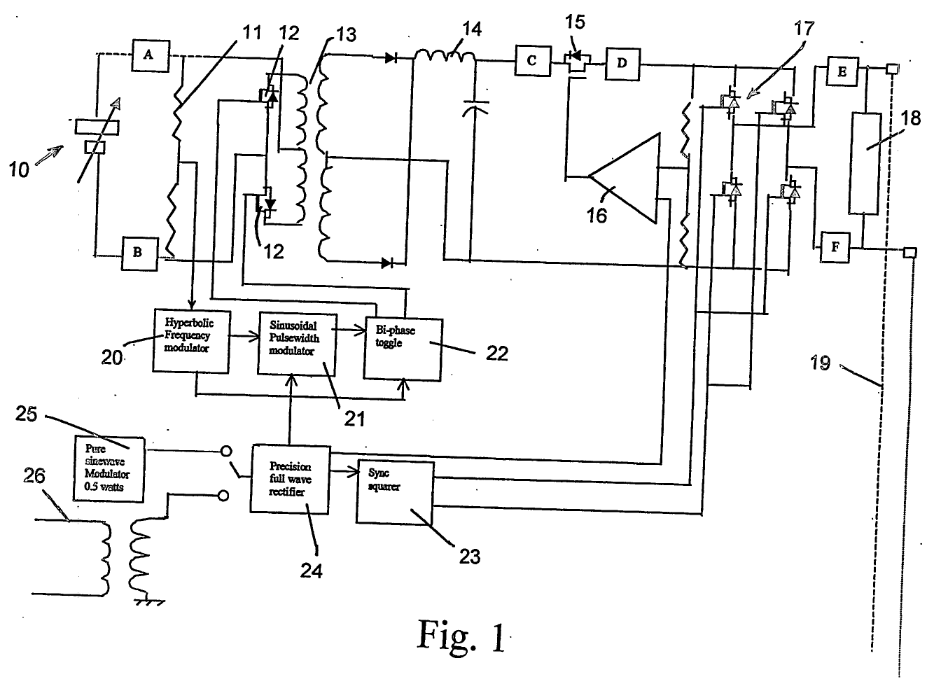

Referring to FIG. 1, it shows a block diagram representing a preferred embodiment of the inverter according to the present invention. The input 10 to the inverter is a variable DC source, such as a battery bank, fuel cell, solar cell bank and the like. DC voltage variations can be essentially limitless, but for the purposes of this embodiment, the minimum voltage is chosen to be 50 VDC and the maximum voltage 100 VDC. This unstable DC power is connected to the inverter at entry points “A” and “B”. Power out can also be any desired value, but herein it is chosen to be 115 VAC, 60 hz, 45 amps, i.e. 5 kilowatts. It is provided at exit points “E” and “F” of the inverter where the user's appliances requiring stable AC power are connected.

A voltage divider 11 is provided for feeding a fraction of the line voltage from input 10 to a hyperbolic frequency modulator 20. Two push-pull switching FETs or FET modules 12 are connected to a bi-phase toggle 22 which is a flip-flop that produces phases A and B for the FET drives of the push-pull stage. These phases are 60 hz square-pulses originating from sync squarer 23 which are used to reconstruct the complete power sinewave (i.e. positive and negative alternances). For this embodiment 200V, 50 amps FETs have been chosen. Then push-pull stage is followed by a high frequency transformer 13 which, for this embodiment has been chosen as a 5 kw, 100 kilohertz transformer. The role of the transformer is to isolate the DC input from the AC output, and to raise the voltage levels to the correct 160 v peak necessary to a 115 vrms power sinewave. This is followed by an integrating ferrite choke 14 which is used for averaging high frequency pulses in order to produce the low frequency (60 hz) and which in this case is a 300 microhenries choke, connected to a FET pass element 15 located between points “C” and “D” of the inverter and used to produce a low drop linear regulator. A standard op amp error amplifier 16 is provided for the linear regulator, whose reference input receives, in this case, 60 hz half-sine waves at 10v amplitude. This is followed by a FET synchronous full bridge 17 used to convert unidirectional half sinewaves into full sinewaves, and leading to the user's load 18 which can be any complex impedance. The AC power out at points “E” and “F” can also be fed to a grid 19 if the inverter is used to feed such a grid.

The hyperbolic frequency modulator 20 produces a frequency k/v where v is proportional to the line voltage and the hyperbola curve fit is preferably exact within ±1%. The frequency modulated voltage from the modulator 20 is fed to a sinusoidal pulsewidth modulator 21 which produces a pulse triggered by the k/v frequency and whose width is proportional preferably within ±1% to the reference half sinewave amplitude produced by a precision full wave rectifier 24 which is a low power (normally 100 milliwatt) rectifier with no offset and having a standard management with the op amp 16. It also provides a reference signal for any master-slave arrangement that might be needed for powers exceeding 5 kilowatts. Thus, the hyperbolic frequency modulator 20 triggers the sinusoidal pulsewidth modulator 21 to obtain a frequency that varies hyperbolically and a pulsewidth that varies sinusoidally. The combination of these two functions produces regulation and sinewave output. The hyperbolic frequency modulator 20 also sends synchronizing signals to the bi-phase toggle 22 to produce bi-phase signals. The sync squarer 23 is a simple pulse shaping circuit producing the synchronization pulses for the FET synchronous full bridge 17 that converts unidirectional half sinewaves into full sinewaves.

As an internal sine reference to the precision full wave rectifier 24, there may be provided a pure sinewave modulator 25, which is a high priority, high stability, low power (100 milliwatts, 60 hz) sinewave generator, such as Wien bridge or a crystall controlled sinewave generator.

Moreover, an external sine reference from the grid 16 may be provided, which is a small 1 watt 60 hz transformer that will output a low voltage signal mimicking exactly the grid voltage. This signal is subsequently fed as a reference to the precision full wave rectifier 24 and to sinusoidal pulsewidth modulator 21 and the sync squarer 23, exactly as the internal reference. The net effect is that the output of the inverter will also exactly mimic the voltage of the grid 16 even if the grid voltage is not exactly sinusoidal. This feature is particularly interesting if the inverter has to deliver power to the grid. The approximate component cost of a 5 kw inverter having the arrangement described above and illustrated in FIG. 1 is as follows:

| | |
|---|---|
| 7 power FETs at $4.00 each | $28.00 |
| 1 5 kw transformer, 100 Khz | $50.00 |
| 20 standard CMOS and linear Ics | $10.00 |
| 2 fast rectifiers | $8.00 |
| 1 small transformer, 1 va | $5.00 |
| 1 choke, 300 microhenries | $10.00 |

The total of $111.00 is very close to the $ 0.05/watt objective mentioned above. It should be noted that no software is implied in this design and troubleshooting can be readily accomplished by any technician having reasonable knowledge of analog circuits.

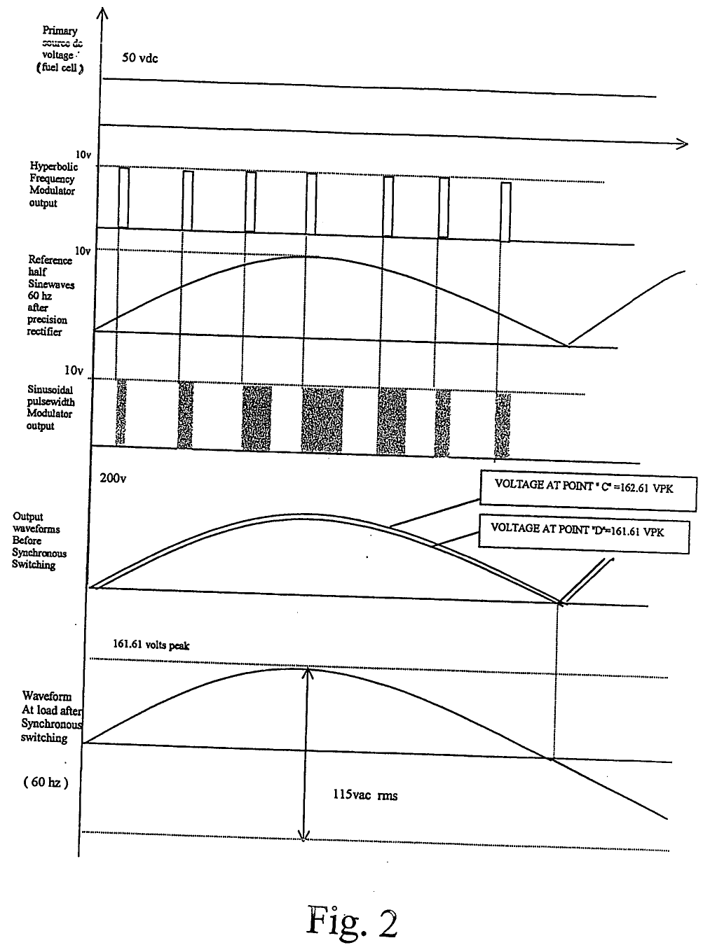

Referring to FIG. 2, it shows the waveforms occurring at different points of the block diagram of FIG. 1 when voltage from the primary DC source 10 (e.g. a fuel cell bank) is at its lowest value, in this case 50 VDC. For the sake of readability, only seven pulses of frequency modulator 20 output are represented, although there are about 700 during one 60 hz half period.

As shown in FIG. 2, at the output of the hyperbolic frequency modulator 20, the waveform has a narrow rectangular shape. Then the reference half sinewave (60 hz) are shown as formed after the precision rectifier 24. Then follows the sinusoidal output of the pulsewidth modulator 21 and thereunder are shown the output waveforms before the synchronous switching 17 with voltage at point “C” being 162.01 VPK and at point “D” being 161.61 VPK. Finally, the waveform at load 18 after the synchronous switching 17 is shown at the bottom of FIG. 2, producing a pure sinusoidal waveform of constant amplitude (115 VAC rms) and a constant frequency (60 hz).

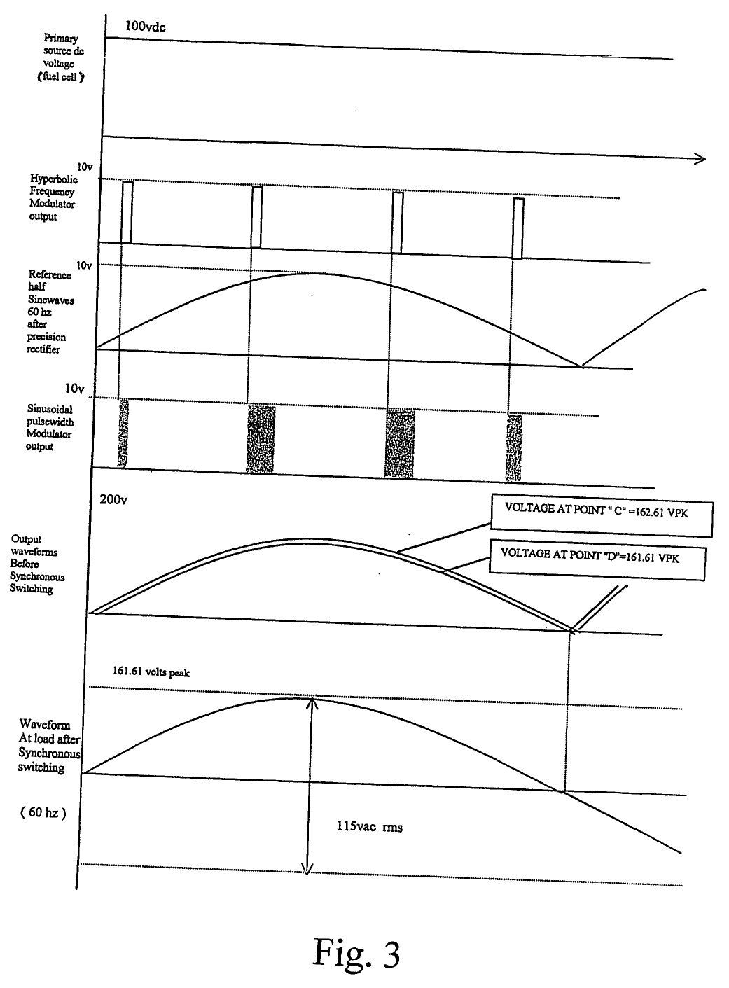

FIG. 3 shows the main waveforms when the primary DC source 10 delivers its maximum DC voltage, in this case 100 VDC. For the sake of readability, only 4 pulses of the output of the frequency modulator 20 are represented, but there are about 350 during one 60 hz half period.

As shown in FIG. 3, at the output of the hyperbolic frequency modulator 20, the waveform has a narrow rectangular shape. It is similar to the waveform shown in FIG. 2, but there are only 4 pulses for the period where 7 pulses were produced at the minimum DC voltage. The reference half sinewave (60 hz) after the precision rectifier 24 are shown under the hyperbolic frequency modulator output. Then follows the output of the sinusoidal pulsewidth modulator 21 and thereunder are shown the output waveforms before the synchronous switching 17, with voltage at point “C” being 62.61 VPK and at point “D” being 161.61 VPK which is exactly the same as in FIG. 2 for the minimum DC voltage. Finally, the waveform at load 18 after the synchronous switching 17 is shown at the bottom of FIG. 3, producing as in FIG. 2, a pure sinewave, 60 hz, 115 VAC rms, line and load regulated.

Obviously, for all intermediate values between minimum and maximum voltages from the primary DC source 10, the output of the inverter will also be a pure sinewave, 60 hz, 115 vac rms, line and load regulated. It should be noted that in this example, the primary DC source voltage varies by a factor of 2 (50 VDC to 100 VDC). Hence, the hyperbolic modulation curve fit has to be exact only over a 1 to 2 range. However, if the primary DC voltage were to vary by a factor of 5 (e.g. 20 VDC to 100 VDC), the hyperbolic modulation fit would be exact over a 1 to 5 range. This has been confirmed by calculations according to the formulae given in U.S. Pat. No. 5,357,418 as well as by numerous designs performed by the applicant.

The invention is not limited to the specific embodiment and examples described above, but various modifications obvious to those skilled in the art can be made without departing from the invention and the following claims.

1. A sinewave inverter characterized in that it comprises a combination of an open loop hyperbolic frequency modulator with a sinusoidal pulsewidth modulator followed by a linear regulator, producing a line and load regulated distortionless sinusoidal voltage.

2. A sinewave inverter according to claim 1, in which the hyperbolic frequency modulator is adapted to produce high frequency which is exactly inversely proportional to a variable input DC voltage.

3. A sinewave inverter according to claim 1, in which the sinusoidal pulsewidth modulator is adapted to produce a pulsewidth exactly proportional to the voltage of a sinusoidal distortionless reference voltage from a pure sinewave modulator.

4. A sinewave inverter according to claim 1, in which the sinusoidal pulsewidth modulator is adapted to produce a voltage which is exactly proportional to the voltage from a grid, thereby enabling the inverter to produce AC voltage which exactly mimics the grid voltage amplitude, frequency and waveshape and hence can deliver power to the grid.

5. A sinewave inverter according to claim 1, further comprising a precision full wave rectifier adapted to provide a reference signal from a master-slave arrangement suitable to deliver any desired power output.

6. A sinewave inverter using a hybrid regulator for converting DC input voltage from a variable DC source to pure sinewave line and load regulated AC voltage at the output, which comprises:
(a) a hyperbolic frequency modulator for producing high frequency which is exactly inversely proportional to the variable input DC voltage;
(b) a voltage divider for feeding a fraction of the input voltage to said hyperbolic frequency modulator;
(c) a sinusoidal pulsewidth modulator producing a pulse triggered by the modulated frequency from the hyperbolic frequency modulator and whose width is exactly proportional to the reference half sinewave amplitude from an internal or external sine reference source and a precision full wave rectifier;
(d) a pair of push-pull switching FETs connected to a bi-phase toggle which is triggered by the sinusoidal pulsewidth modulator and the hyperbolic frequency modulator and providing a flip-flop for the two phases of FET drives of the push-pull stage;
(e) a high frequency transformer following the push-pull stage connected to an integrating choke which itself is connected to a FET pass element used to produce a low drop linear regulator which is provided with an amplifier whose reference input receives half-sine waves from the linear regulator; and
(f) a FET synchronous bridge for converting the amplified half sine waves obtained from the linear regulator into full sinewaves of AC voltage at the output of the inverter.

7. A sinewave inverter according to claim 6, in which the input voltage is unstable DC voltage provided by batteries, fuel cells, wind mills, photovoltaic cells or solar cells.

8. A sinewave inverter according to claim 6, in which the pure sinewave produced at the output has less than 2% harmonic distortion.

9. A sinewave inverter according to claim 6, in which the hyperbolic frequency modulator which produces a pulsewidth exactly inversely proportional to the variable input DC voltage has an exactitude of ±1%.

10. A sinewave inverter according to claim 6, in which the sinusoidal pulsewidth modulator which produces a pulse whose width is exactly proportional to the reference half sinewave amplitude from a reference source has an exactitude of ±1%.

11. A sinewave inverter according to claim 2, in which the sinusoidal pulsewidth modulator is adapted to produce a pulsewidth exactly proportional to the voltage of a sinusoidal distortionless reference voltage from a pure sinewave modulator.

12. A sinewave inverter according to claim 2, in which the sinusoidal pulsewidth modulator is adapted to produce a voltage which is exactly proportional to the voltage from a grid, thereby enabling the inverter to produce AC voltage which exactly mimics the grid voltage amplitude, frequency and waveshape and hence can deliver power to the grid.

13. A sinewave inverter according to claim 2, further comprising a precision full wave rectifier adapted to provide a reference signal from a master-slave arrangement suitable to deliver any desired power output.

14. A sinewave inverter according to claim 3, further comprising a precision full wave rectifier adapted to provide a reference signal from a master-slave arrangement suitable to deliver any desired power output.

15. A sinewave inverter according to claim 4, further comprising a precision full wave rectifier adapted to provide a reference signal from a master-slave arrangement suitable to deliver any desired power output.

16. A sinewave inverter according to claim 7, in which the pure sinewave produced at the output has less than 2% harmonic distortion.

17. A sinewave inverter according to claim 7, in which the hyperbolic frequency modulator which produces a pulsewidth exactly inversely proportional to the variable input DC voltage has an exactitude of ±1%.

18. A sinewave inverter according to claim 8, in which the hyperbolic frequency modulator which produces a pulsewidth exactly inversely proportional to the variable input DC voltage has an exactitude of ±1%.

19. A sinewave inverter according to claim 7, in which the sinusoidal pulsewidth modulator which produces a pulse whose width is exactly proportional to the reference half sinewave amplitude from a reference source has an exactitude of ±1%.

20. A sinewave inverter according to claim 8, in which the sinusoidal pulsewidth modulator which produces a pulse whose width is exactly proportional to the reference half sinewave amplitude from a reference source has an exactitude of ±1%.
